(19) United States
(12) Patent Application Publication
(10) Pub. No.: US 2022/0360102 A1
(43) Pub. Date: Nov. 10, 2022

(54) CHARGING APPARATUS AND CHARGING METHOD

(71) Applicant: SCHNEIDER ELECTRIC (AUSTRALIA) PTY LTD, Macquarie Park (AU)

(72) Inventors: Guoqiang Zhang, Shenzhen (CN); Zhen Ma, Shenzhen (CN)

(73) Assignee: SCHNEIDER ELECTRIC (AUSTRALIA) PTY LTD, Macquarie Park (AU)

(21) Appl. No.: 17/737,136

(22) Filed: May 5, 2022

(30) Foreign Application Priority Data
May 6, 2021 (CN) 202110491353.6

(51) Int. Cl. H02J 7/00

(52) U.S. Cl. CPC H02J 7/007192; H02J 7/0042; H02J 7/0047; H02J 7/00712

(57) ABSTRACT

Embodiments of the present disclosure provide a charging apparatus and a charging method. The charging apparatus comprises: a housing adapted to be mounted in wall; a power assembly arranged within the housing and configured to supply output power to a device to be charged from a power source; a temperature sensing unit, arranged within the housing and configured to sense temperature inside the housing; a control assembly arranged within the housing and coupled to the power assembly and the temperature sensing unit, the control assembly being configured to control, based on temperature information from the temperature sensing unit, the power assembly to change the output power, thereby suppressing rise of temperature inside the housing. In accordance with embodiments of the present disclosure, the charging apparatus mounted in the wall can provide an effectively boosted charging power and is further applied to a broader scope.

### FIELD

Embodiments of the present disclosure relate to the field of power supply, and more specifically, to a charging apparatus and a charging method.

### BACKGROUND

Charging apparatus, such as a wall socket charger, may be embedded in the wall and charge electronic devices, e.g., smartphones and tablet computers, by connecting with them via a terminal such as a USB port. The charging apparatus usually supplies rated voltage and current including 5V/1 A, 5V/1.5 A, 5V/2.1 A, 5V/3.1 A, etc.

At present, some electronic devices demand a constantly growing charging power. For this, the charging power of the charging apparatus should also be continuously raised. For example, some charging apparatuses, like wall sockets, have been able to supply a charging power of 18 W and 21 W or even higher. Despite that, the mounting conditions of these charging apparatuses have barely changed. For instance, the 86-type wall outlet box (86 mm×86 mm) is still used in domestic. In other words, the standard dimension of the wall outlet box for the charging apparatus stays unchanged. Such restricted mounting conditions account for bad heat-dissipating conditions of the charging apparatuses, like wall sockets. Therefore, if the charging power continues to go up, it is hard to guarantee the charging performance and charging safety.

Since the charging power could no longer be increased, the charging apparatus, like wall socket, may be applied to a quite restricted range. For example, the notebook computers usually demand a charging power above 45 W. Besides, some novel smartphones and tablet computers also need a growing charging power, to satisfy the constantly enhanced performance. In such case, the existing charging apparatus, like wall socket, could not be applied to charge the electronic devices with a high power demand due to the restricted charging power.

### SUMMARY

In view of the above problems, there is provided a charging apparatus and a charging method in accordance with example implementations of the present disclosure.

In a first aspect of the present disclosure, there is provided a charging apparatus, comprising: a housing adapted to be mounted in a wall; a power assembly arranged within the housing and configured to supply output power to a device to be charged from a power source; a temperature sensing unit configured to sense a temperature inside the housing; a control assembly arranged within the housing and coupled to the power assembly and the temperature sensing unit, the control assembly being configured to control, based on temperature information from the temperature sensing unit, the power assembly to change the output power, thereby suppressing a rise of the temperature inside the housing.

In accordance with embodiments of the present disclosure, the charging apparatus may output the maximum power for as long as possible while the performance and safety of the charging apparatus is not affected by overheating. In such way, the charging apparatus mounted in the wall can provide an effectively boosted charging power and is further applied to a broader scope. For example, the charging apparatus may be adapted for electronic devices such as notebook computer desiring a higher charging power.

In some embodiments of the present disclosure, the temperature sensing unit is arranged proximate to at least one of the power assembly and the control assembly, to sense a temperature of at least one of the power assembly and the control assembly. Therefore, when the temperature sensing unit is arranged proximate to the power assembly and/or control assembly, the temperature information can be more accurately acquired, which may further boost the overall performance of the charging apparatus.

In some embodiments of the present disclosure, the power assembly comprises a switching device, and the control assembly comprises a processing unit; and wherein the temperature sensing unit is arranged proximate to at least one of the switching device and the processing unit, to sense a temperature of at least one of the switching device and the processing unit. The switching device and the processing unit are core components and main heat sources of the power assembly and the control assembly respectively. Accordingly, through the above arrangement, the temperature condition of the core components is more accurately sensed and the performance and operations of the charging apparatus are further improved.

In some embodiments of the present disclosure, the control assembly is configured to: transmit a signal to the power assembly in response to the temperature information indicating a temperature above a first threshold, to change an output power of the power assembly from a first power to a second power, the second power being lower than the first power. Through the above operations, the charging apparatus may output the maximum power for as long as possible without causing overheating.

In some embodiments of the present disclosure, the control assembly is configured to transmit a signal to the power assembly in response to the temperature information indicating a temperature below a second threshold, to change output power of the power assembly from the second power to the first power, the second threshold being lower than the first threshold. In this embodiment, the charging power of the charging apparatus may be repeatedly adjusted without manual intervention, such that the charging apparatus would immediately output at the maximum power once the temperature reduces to the safe level. On this basis, the actual power output of the charging apparatus is greatly improved.

In some embodiments of the present disclosure, the charging apparatus further comprises: a USB output port coupled to the power assembly to supply the output power to the device to be charged. In this embodiment, the USB port may transmit power signals and data signals simultaneously. Besides, the charging apparatus may directly connect to the USB port of the device to be charged. As such, charging becomes more convenient.

In some embodiments of the present disclosure, the charging apparatus also comprises a voltage and current sensing unit coupled to the power assembly to sense voltages and currents in the power assembly; and wherein the control assembly is further configured to: control the power assembly based on voltage and current information from the voltage and current sensing unit and demand information related to charging requirements of the device to be charged from the USB output port. In this embodiment, the feedback voltage and current information may assist the charging apparatus to more accurately obtain the desired output power. Besides, the charging apparatus may be conveniently adjusted based on the charging requirement information obtained via the USB output port, to match with the device to be charged. Thus, the charging apparatus may be applied to a wider range.

In some embodiments of the present disclosure, the control assembly comprises: a first controller coupled to a switching device of the power assembly and the voltage and current sensing unit, and configured to control ON and OFF of the switching device based on the voltage and current information from the voltage and current sensing unit; and a second controller coupled to the temperature sensing unit, the USB output port and the first controller, and configured to provide a command signal to the first controller based on the temperature information from the temperature sensing unit and the demand information from the USB output port, so as to enable the first controller to control ON and OFF of the switching device further based on the command signal. In such embodiment, owing to the two controllers provided at the same time, the operational tasks and the operations for controlling the switching device can be more efficiently handled, and the running efficiency and overall performance of the charging apparatus is improved.

In a second aspect of the present disclosure, there is provided a charging method, comprising: providing, by a power assembly, an output power from a power source to a device to be charged, wherein the power assembly is arranged within a housing that is adapted to be mounted in a wall; sensing, by a temperature sensing unit, a temperature inside the housing, wherein the temperature sensing unit is arranged within the housing; and controlling, by a control assembly, the power assembly based on temperature information from the temperature sensing unit to change the output power, thereby suppressing a rise of the temperature inside the housing.

In some embodiments of the present disclosure, the temperature sensing unit is arranged proximate to at least one of the power assembly and the control assembly, to sense a temperature of at least one of the power assembly and the control assembly.

In some embodiments of the present disclosure, the power assembly comprises a switching device, and the control assembly comprises a processing unit; and wherein the temperature sensing unit is arranged proximate to at least one of the switching device and the processing unit, to sense a temperature of at least one of the switching device and the processing unit.

In some embodiments of the present disclosure, controlling, by the control assembly, the power assembly based on the temperature information from the temperature sensing unit to change the output power comprises: in response to the temperature information indicating a temperate above a first threshold, transmitting by the control assembly a signal to the power assembly, to change the output power of the power assembly from a first power to a second power, the second power being lower than the first power.

In some embodiments of the present disclosure, controlling, by the control assembly, the power assembly based on the temperature information from the temperature sensing unit to change the output power further comprises: in response to the temperature information indicating a temperature below a second threshold, transmitting by the control assembly a signal to the power assembly, to change the output power of the power assembly from the second power to the first power, the second threshold being lower than the first threshold.

In some embodiments of the present disclosure, the charging method further comprises: controlling, by the control assembly, the power assembly based on voltage and current information from a voltage and current sensing unit and demand information related to charging requirements of the device to be charged from the USB output port, wherein the voltage and current sensing unit is coupled to the power assembly to sense voltages and currents in the power assembly, and the USB output port is coupled to the power assembly to supply the output power to the device to be charged.

It should be appreciated that the contents described in this Summary are not intended to identify key or essential features of the implementations of the present disclosure, or limit the scope of the present disclosure. Other features of the present disclosure will be understood more easily through the following description.

### BRIEF DESCRIPTION OF THE DRAWINGS

Through the following detailed description with reference to the accompanying drawings, the above and other features, advantages and aspects of various implementations of the present disclosure will become more apparent. In the drawings, the same or similar reference signs indicate same or similar elements, wherein:

FIG. 1 illustrates a perspective view of a charging apparatus in accordance with embodiments of the present disclosure;

FIG. 2 illustrates a schematic circuit diagram in which the charging apparatus in accordance with embodiments of the present disclosure is connected with a power source and a load;

FIG. 3 illustrates a more detailed schematic circuit diagram of the charging apparatus in accordance with embodiments of the present disclosure;

FIG. 4 illustrates a schematic flowchart of a charging method in accordance with a further embodiment of the present disclosure;

FIG. 5 illustrates a schematic flowchart of a method for implementing details of the blocks in a method in accordance with a further embodiment of the present disclosure.

### DETAILED DESCRIPTION OF EMBODIMENTS

The implementations of the present disclosure will be described below in more details with reference to the drawings. Although the drawings illustrate some implementations of the present disclosure, it should be appreciated that the present disclosure can be implemented in various manners and should not be limited to the implementations explained herein. On the contrary, the implementations are provided to enable those skilled in the art to understand the present disclosure more thoroughly and completely. It should be appreciated that the drawings and implementations of the present disclosure are exemplary only and are not intended for restricting the protection scope of the present disclosure.

In the description of implementations disclosed herein, the term “includes” and its similar expressions are to be read as open-ended terms that mean “includes, but is not limited to.” The term “based on” is to be read as “based at least in part on.” The terms “one example embodiment/implementation” and “this embodiment/implementation” are to be read as “at least one embodiment/implementation.” The terms “first”, “second” and so on can refer to same or different objects. The following text also can include other explicit and implicit definitions.

The present disclosure proposes an improved charging solution adapted for a charging apparatus like wall sockets. Temperature is detected within the charging apparatus as the basis for power output adjustment. As a result, the charging apparatus may output the maximum charging power for as long as possible while its performance and safety are guaranteed. Thus, high-power quick charge may be implemented on the charging apparatus, such as wall socket.

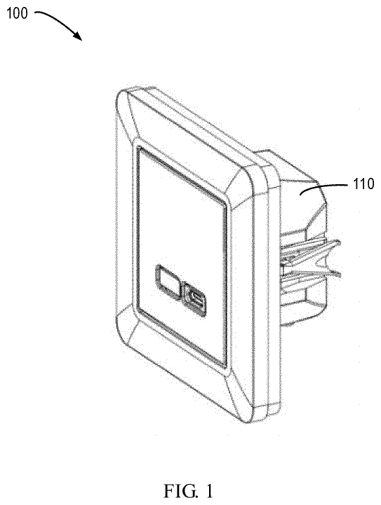

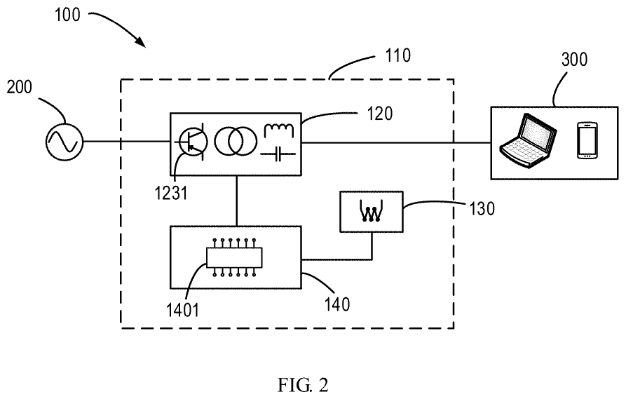

FIG. 1 illustrates a perspective view of a charging apparatus 100 in accordance with embodiments of the present disclosure, and FIG. 2 illustrates a schematic circuit diagram in which the charging apparatus 100 in accordance with embodiments of the present disclosure is connected with a power source 200 and a load 300.

As shown in FIGS. 1 and 2, in embodiments of the present disclosure, the charging apparatus 100 may include a housing 110 adapted for mounting in the wall. Specifically, the housing 100 may be made of an insulating material to receive electrical and electronic components. The housing 110 may be mounted in the wall. In this way, the entire charging apparatus 100 may be disposed in the wall, to connect with and charge the electronic device to be charged. Accordingly, the housing 110 may be provided with corresponding elements for securing to the wall. As an example, the housing 110 may include a 86-type wall outlet box (provided with a front surface having a dimension of length and width of 86 mm×86 mm) which is widely used in domestic.

In the embodiments of the present disclosure, the charging apparatus 100 may include a power assembly 120, which may be disposed within the housing 110. The power assembly 120 is configured to provide output power to a device 300 to be charged from the power source 200.

As an example, the power source 200 may be a public electrical network that supplies an alternating voltage of 110V or 220V, and the device 300 to be charged may be a smartphone, a tablet computer, a notebook computer or other portable electronic devices. It is to be understood that the power source 200 also may be a DC power source, or other types of power sources that can supply electricity, such as storage cells, super-capacitors, and electric networks at other voltage levels etc. In addition, the device 300 to be charged may be other rechargeable electronic devices or electronic products, e.g., wearable devices including earphones, smart watches and Virtual Reality (VR) glasses etc. Meanwhile, the power assembly 120 may include proper electrical and electronic components to convert voltages and currents from the power source 200 into voltages and currents desired by the device 300 to be charged. Thus, a charging power is supplied to the device 300 to be charged.

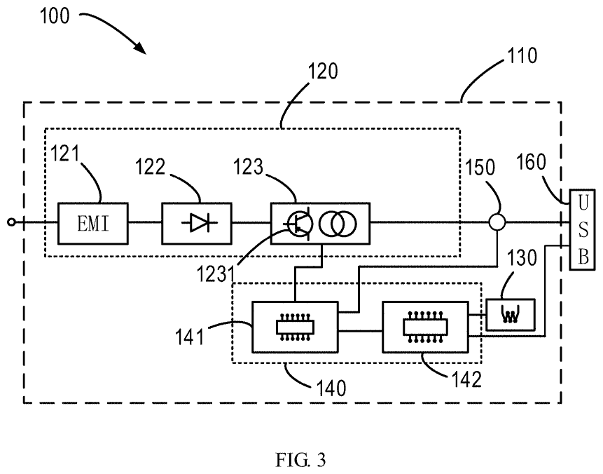

FIG. 3 illustrates a more detailed schematic circuit diagram of the charging apparatus 100 in accordance with embodiments of the present disclosure. Just as an example, the power assembly 120 may include an EMI circuit 121 for eliminating electromagnetic interference between the power source 200 and the charging apparatus 100, as shown in FIG. 3. The power assembly 120 also may include a rectifier filter circuit 122 and a power conversion circuit 123. The rectifier filter circuit 122 may convert power from the AC power source into DC power. For example, the rectifier filter circuit 122 may be a half-bridge rectifier circuit, a full-bridge rectifier circuit or any other rectifier circuits of suitable types. Besides, the rectifier filter circuit 122 also may include a proper filter circuit that eliminates noises and ripples by filtering. The power conversion circuit 123 may be featured with power or energy conversion function. For instance, the power conversion circuit 123 may be a flyback conversion circuit. It is to be understood that the power conversion circuit 123 also may be other suitable types of DC-DC conversion circuits (e.g., boost circuit, buck circuit or boost-buck circuit). In some cases, the power conversion circuit 123 may also be AC-DC conversion circuit (e.g., with rectifier filter circuit 122 being omitted) or other types of conversion circuits. It is to be noted that the components included in the power assembly 120 are not limited to the above listed circuits. For example, the power assembly 120 also may include a protection circuit and additional filter circuits (e.g., between the power conversion circuit 123 and the output port). In addition, connections between the above respective circuits within the power assembly 120 are not limited to those illustrated in FIG. 3, and any necessary adjustments may be performed.

In the embodiments of the present disclosure, the charging apparatus 100 may include a temperature sensing unit 130 configured to sense the temperature inside the housing 110. For example, the temperature sensing unit 130 may be disposed within the housing 110. Alternatively, the temperature sensing unit 130 also may be arranged external to the housing 110. In such case, the housing 110, for example, may be provided with an opening, through which the temperature sensing unit 130 senses the temperature inside the housing 110. However, the above arrangement is just exemplary, and the temperature sensing unit 130 may be disposed at any suitable positions as long as it can sense the temperature inside the housing 110. For example, the temperature sensing unit 130 also may be disposed in a wall around the housing 110, and the temperature inside the housing 110 may be deduced and determined through heat transfer of wall materials. As an example, the temperature sensing unit 130 may include a negative temperature coefficient NTC element. However, it is to be appreciated that the temperature sensing unit 130 may include any suitable types of elements for temperature sensing, e.g., thermocouple, thermal resistance or thermistor.

In the embodiments of the present disclosure, the charging apparatus 100 may include a control assembly 140 disposed within the housing 110 and coupled to the power assembly 120 and the temperature sensing unit 130. The control assembly 140 is configured to control the power assembly 120 based on the temperature information from the temperature sensing unit 130, to alter the output power and thereby suppress a rise of the temperature inside the housing 110. For example, the control assembly 140 may include an integrated circuit or chip, which may receive a temperature-indicating signal from the temperature sensing unit 130, and adjust the power that is supposed to be output by the power assembly 120 at least based on the temperature-indicating signal. For example, the above arrangement may prevent the power assembly from outputting the maximum power in case of overtemperature and lower the temperature inside the housing 110.

As stated above, heat dissipation in the charging apparatus mounted in the wall is less satisfactory than a portable charging apparatus. On this basis, the power output by the charging apparatus in the wall would be restricted at a relatively low level on account of bad heat-dissipating conditions. The temperature sensing provided in the charging apparatus and the adjustment of output power based on the temperature sensing allow the charging apparatus to output the maximum power for as long as possible without causing overheating of the charging apparatus. In such way, high-power charging may be implemented in the charging apparatus, such as wall sockets (e.g., the electronic devices requiring a higher power like notebook computers may be charged). Furthermore, the high-power quick charge, which is usually impossible in existing chargers mounted in the wall, could also be fulfilled.

In accordance with some embodiments of the present disclosure, the control assembly 104 may be configured to: transmit a signal to the power assembly 120 in response to temperature information from the temperature sensing unit 130 indicating a temperature above a first threshold, to change the output power of the power assembly 120 from a first power to a second power below the first power. For example, the charging apparatus 100 may output the maximum output power (up to 65 W for example) at the initial phase of charging. After a period of time elapsed (such as 60 minutes), the output power may be reduced to a certain value (e.g., 45 W) which guarantees temperature drop upon an excessive temperature is detected (i.e., exceeding the first threshold, e.g., 120° C.). Through the above operations, the charging apparatus 100 may output the maximum power for as long as possible without causing overheating.

In accordance with some embodiments of the present disclosure, the control assembly 140 may be configured to transmit a signal to the power assembly 120 in response to temperature information from the temperature sensing unit 130 indicating a temperature below a second threshold, so as to change the output power of the power assembly 120 from the second power to the first power, where the second threshold is lower than the first threshold. For example, when the charging apparatus 100 has operated at a relatively low output power (e.g., 45 W) for a time period, the temperature inside the housing 110 of the charging apparatus 100 reduces to a relatively safe level (i.e., below the second threshold, such as 90° C. or 100° C.). In such case, the charging apparatus 100 may be re-adjusted to the maximum output power (i.e., 65 W at the initial phase of charging). Therefore, the charging power of the charging apparatus 100 may be repeatedly adjusted without manual intervention, such that the charging apparatus 100 would immediately output at the maximum power once the temperature inside the housing 110 reduces to the safe level. On this basis, the charging efficiency is greatly improved and the high-power quick charge is more easily achieved.

In accordance with some embodiments of the present disclosure, the temperature sensing unit 130 is arranged proximate to at least one of the power assembly 120 and the control assembly 140, to sense the temperature of at least one of them. Specifically, the power assembly 120 and the control assembly 140 disposed within the housing 110 are the main functional components and heat-generating sources of the charging apparatus 100. Therefore, when the temperature sensing unit 130 is arranged proximate to the power assembly 120 and/or control assembly 140, the temperature information can be more accurately acquired, which may further boost the overall performance of the charging apparatus. Besides, it is to be understood that alternatively only the power assembly 120 or the control assembly 140 is directly sensed for temperature condition and the sensed temperature condition may further serve as the basis for deducing or obtaining the temperature condition of the other. For example, on account of the association between the operating states of the power assembly 120 and the control assembly 140, the temperature of one of the power assembly 120 and control assembly 140 may determine the temperature of the other indirectly. Thus, fewer temperature sensing units are arranged, which lowers costs and saves space.

In accordance with some embodiments of the present disclosure, the power assembly 120 includes a switching device 1231, and the control assembly 140 includes a processing unit 1401. The temperature sensing unit 130 is arranged proximate to at least one of the switching device 1231 and the processing unit 1401, to sense the temperature of one of them. For example, the switching device 1231 may operate at a desired duty cycle between ON and OFF. For instance, the switching device 1231 may operate in a pulse width modulation (PWM) way between ON and OFF. The switching device 1231 includes, but not limited to, Insulated Gate Bipolar Transistor (IGBT), Junction Field Effect Transistor (JFET), Bipolar Junction Transistor (BJT), Metal Oxide Semiconductor Field Effect Transistor (MOSFET), Gate Turn Off Thyristor (GTO), MOS controlled thyristor (MCT), Integrated Gate Commutated Thyristor (IGCT), silicon carbide (SiC) switching device or gallium nitride (GaN) switching device. The processing unit 1401 may receive various measurement signals (including signals indicating temperature), and provide proper control signals, e.g., PWM-controlled signal, to the switching device 1231 based on the measurement signals and a predetermined policy. The processing unit 1401 includes, but not limited to, single-chip microcomputer, microcontroller, arithmetic logic unit (ALU), central processing unit (CPU), digital signal processor (DSP) and field programmable gate array (FPGA) etc.

The switching device 1231 and the processing unit 1401 are core components of the power assembly 120 and the control assembly 140 respectively. During the operation of the charging apparatus 100, the switching device 1231 gives massive heat due to high-frequency switching operations, and the excessively high temperature will degrade operating performance of the switching device 1231 and possibly further affect the operating state of the charging apparatus 100. Likewise, during the operation of the charging apparatus 100, the processing unit 1401 undertakes most of the operational processing (e.g., operations for PWM control and operations for determining temperature and control signals) and is the main heat source for the control assembly 140. Accordingly, by arranging the temperature sensing unit 130 proximate to the switching device 1231 and the processing unit 1401, the temperature condition of the core components is more accurately sensed and the performance and operations of the charging apparatus 100 are further improved. Besides, it is to be understood that alternatively only the switching device 1231 or the processing unit 1401 is directly sensed for temperature condition and the sensed temperature condition may further serve as the basis for deducing or obtaining the temperature condition of the other. For example, on account of the association between the operating states of the switching device 1231 and the processing unit 1401, the temperature of one of the switching device 1231 and processing unit 1401 may determine the temperature of the other indirectly. Thus, fewer temperature sensing units are arranged, which lowers costs and saves space. Moreover, when temperature at a plurality of positions or of a plurality of devices is acquired simultaneously, the plurality of temperature information may be integrated to determine the overall temperature condition of the charging apparatus 100. For example, the overall temperature condition of the charging apparatus may be determined based on the importance of the position or device to be sensed and the accuracy of the sensing (e.g., assigning weights to temperature information of temperature sensing units at various positions or of different devices).

In some embodiments of the present disclosure, the charging apparatus 100 also may include a USB output port 160 coupled to the power assembly 120 to provide output power to the device 300 to be charged. Specifically, the USB port may transmit power signals and data signals simultaneously. In such case, the charging apparatus 100 may provide power to the device 300 to be charged while acquiring data information (e.g., data related to charging demands of the device 300) therefrom. Besides, the charging apparatus 100 may directly connect with the device 300 to be charged via the USB port. As such, charging becomes more convenient. It is to be understood that the USB port may be of different types, such as Type-A, Type-B, Type-C or new types of interfaces in the future etc. Besides, the USB port may be a plug (male connector) or a socket (female connector). The USB port may satisfy a variety of specifications, such as USB 1.0, USB 2.0, USB 3.0, USB 3.1, USB 3.2, USB4 or new specifications in the further etc.

In some embodiments of the present disclosure, the charging apparatus 100 also may include a voltage and current sensing unit 150, which is coupled to the power assembly 120 to sense voltages and currents in the power assembly 120. In these embodiments, the control assembly 140 is also configured to control the power assembly 120 based on the voltage and current information from the voltage and current sensing unit 150 and demand information related to the charging requirements of the device 300 to be charged from the USB output port 160. To be specific, the voltage and current sensing unit 150 may sense voltages and currents in the power assembly 120 and feed the voltage and current information to the control assembly 140 for use. On this basis, a closed-loop control is formed to obtain desired power output. In addition to the voltage and current information and the above mentioned temperature information, the control assembly 140 also may determine control signals for the power assembly 120 based on the demand information related to the charging requirements of the device 300 to be charged from the USB output port 160. For example, the control assembly 140 may acquire the charging requirement information (e.g., voltage, current and power) from the device 300 to be charged via the USB port 160, and determine the output power based on the charging requirement information and the configuration of the charging apparatus 100 per se. Afterwards, based on the feedback provided by the voltage and current sensing unit 150, the control assembly 140 ensures that the power assembly 120 outputs the desired power. Hence, different power outputs are provided for various devices to be charged, and the application range is further broadened.

According to FIG. 3, in some embodiments of the present disclosure, the control assembly 140 includes: a first controller 141 and a second controller 142. The first controller 141 is coupled to the switching device 1231 of the power assembly 120 and the voltage and current sensing unit 150, and configured to control ON and OFF of the switching device 1231 based on the voltage and current information from the voltage and current sensing unit 150. The second controller 142 is coupled to the temperature sensing unit 130, the USB output port 160 and the first controller 141, and configured to provide command signals to the first controller 141 based on the temperature information from the temperature sensing unit 130 and the power requirement information related to the device to be charged from the USB output port 160, enabling the first controller 141 to control ON and OFF of the switching device 1231 as a function of the command signals. Specifically, the control assembly 140 may be divided into two parts, i.e., first controller 141 and second controller 142 for implementing distinct control functions. The first controller 141 is mainly used for controlling the switching device 1231 of the power assembly 120, while the second controller 142 primarily communicates with the device 300 to be charged to acquire its power requirement and obtains the temperature information from the temperature sensing unit 130. The first controller 140 and the second controller 142 may communicate with each other to transmit necessary data. Just as an example, the first controller 141 may be PWM controlled circuit for power switching device, and the second controller 142 may be a protocol circuit for the USB port. It is to be appreciated that the control assembly 140 also may be implemented in other ways. As an example, for the control assembly 140, the functions of the first controller 141 and the second controller 142 may be fulfilled by a single circuit (e.g., single microcontroller or processing circuit). Alternatively, the control assembly 140 may include more than two circuits or components. For example, the control assembly 140 also may provide a separate control circuit or component to pass the temperature sensing information to the first controller 141, and a further separate control circuit or component to acquire the power requirement of the device 300 to be charged by communicating with it. As such, the function of the second controller 142 may be implemented by two separate circuits.

In the embodiments of the present disclosure, there is provided a charging apparatus that is adapted to be mounted in the wall and provided with temperature sensing and power regulating features. Such charging apparatus may output the maximum charging power for as long as possible while its performance and safety are guaranteed. Accordingly, the output power of the charging apparatus, e.g., wall socket and the like, may be further boosted. For example, the charging apparatus may continuously output a charging power up to 65 W for a long time. The charging apparatus can be adapted to a greater range of electronic devices with various charging power (e.g., notebook computer and smartphone).

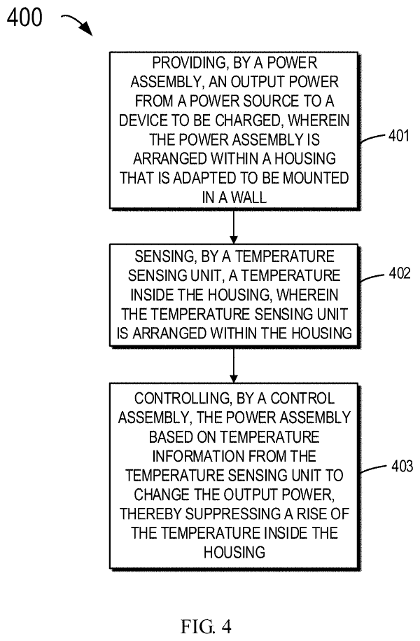

FIG. 4 illustrates a schematic flowchart of a charging method 400 in accordance with a further embodiment of the present disclosure. The charging method 400 is described in details below with reference to FIGS. 2, 3 and 4.

At block 401, output power is provided to the device 300 to be charged via the power assembly 120 from the power source 200. The power assembly 120 is disposed within the housing 110, which is adapted to be mounted in the wall. As an example, the charging apparatus 100 may be adapted to mount in the wall as a whole, to connect with the power source 200. Besides, the device 300 to be charged may be connected to the charging apparatus 100. At the initial phase of charging, the power assembly 120 of the charging apparatus 100 may provide the maximum charging power (e.g., up to 65 W) to the device 300 to be charged.

At block 402, the temperature sensing unit 130, which is arranged within the housing 110, senses the temperature inside the housing 110. In some embodiments of the present disclosure, the temperature sensing unit 130 is arranged proximate to at least one of the power assembly 120 and the control assembly 140, to sense the temperature of at least one of them. In some further embodiments of the present disclosure, the temperature sensing unit 130 is arranged proximate to at least one of the switching device 1231 and the processing unit 1401, to sense the temperature of one of them.

At block 403, the control assembly 140 controls, based on the temperature information from the temperature sensing unit 130, the power assembly 120 to change the output power, thereby suppressing a rise of the temperature inside the housing 110.

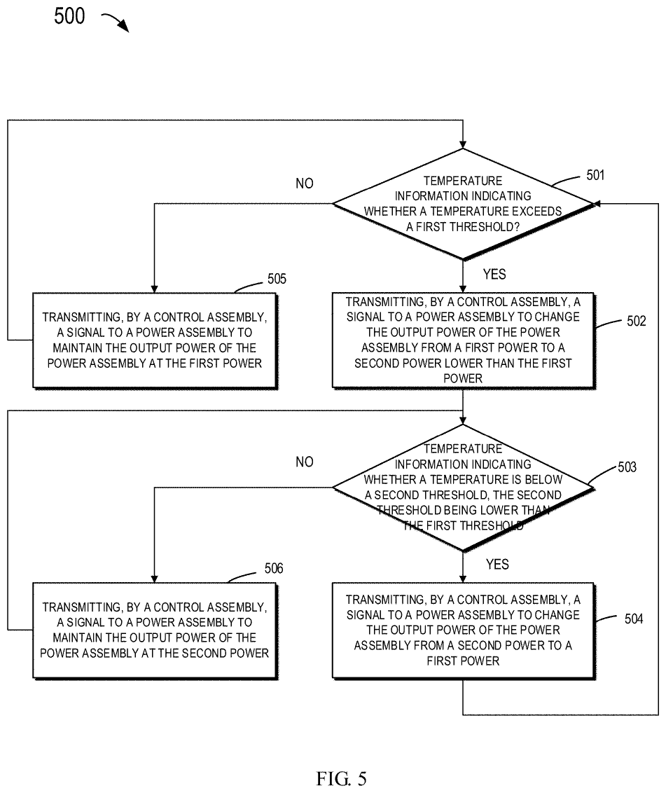

FIG. 5 illustrates a schematic flowchart of a method 500 for implementing details of the block 403 in method 400 in accordance with a further embodiment of the present disclosure.

At block 501, it is determined whether the temperature information from the temperature sensing unit 130 indicates a temperature exceeding a first threshold. As an example, the temperature sensing unit 130 constantly detects the temperature inside the housing 110 of the charging apparatus 100, and provides the temperature information to the control assembly 140, which control assembly 140 will determine whether the temperature exceeds a safety threshold (e.g., 120° C.). At this moment, the charging apparatus 100 may keep outputting the maximum charging power as the first power, e.g., 65 W.

At block 502, the control assembly 140 transmits a signal to the power assembly 120 in response to temperature information indicating a temperature above a first threshold, to change the output power of the power assembly 120 from a first power to a second power below the first power. Specifically, when a temperature exceeds the first threshold, it is indicated that the temperature has already approached the maximum temperature limit of the charging apparatus (possibly affecting performance and safety of the charging apparatus). Accordingly, the control assembly 140 voluntarily controls the power assembly to lower the charging power and reduce the temperature. For example, the output power of the power assembly 120 may be reduced from the maximum level of 65 W to 45 W or even lower (it is to be noted that the reduced charging power should be sufficient to maintain normal charging for the device 300 to be charged). Alternatively, at block 505, the control assembly 140 transmits a signal to the power assembly 120 in response to temperature information indicating a temperature not greater than a first threshold, to maintain the output power of the power assembly 120 at the first power.

At block 503, it is determined whether the temperature information indicates a temperature below the second threshold, the second threshold being lower than the first threshold. To be specific, after power reduction, the control assembly 140 continues to determine the situation of temperature drop in accordance with the temperature information provided by the temperature sensing unit 130, wherein the second threshold may be a sufficiently safe temperature level.

At block 504, the control assembly 140 transmits a signal to the power assembly 120 in response to temperature information indicating a temperature below a second threshold, so as to change the output power of the power assembly 120 from the second power to the first power. Specifically, once the temperature drops to a sufficiently safe level, the output power of the charging apparatus 100 should be re-adjusted to the first power, to ensure that the charging apparatus outputs the maximum charging power for as long as possible. Accordingly, the charging apparatus may output the maximum charging power for a longer time while its performance and safety are guaranteed, and the output power of the charging apparatus, such as wall sockets, is further enhanced. Alternatively, at block 506, the control assembly 140 transmits a signal to the power assembly 120 in response to temperature information indicating a temperature above the second threshold, to maintain the output power of the power assembly 120 at the second power, which is relatively low.

In some embodiments of the present disclosure, the method 400 also may include: controlling, by the control assembly 140, the power assembly 120 based on the voltage and current information from the voltage and current sensing unit 150 and demand information related to the charging requirements of the device 300 to be charged from the USB output port 160.

Through the above description and teachings provided in the related drawings, many modifications and other implementations of the present disclosure disclosed herein will be conceived by those skilled in the field related to the present disclosure. It is to be understood that the implementations of the present disclosure are not limited to the specific implementations disclosed herein, and the modifications and other implementations are included within the scope of the present disclosure. Besides, although the example implementations have been described in the context of some example combinations of the components and/or functions with reference to the related drawings, it should be recognized that different combinations of the components and/or functions may be provided by alternative implementations without deviating from the scope of the present disclosure. As far as this is concerned, other combinations of components and/or functions distinct from the above clearly described ones are also expected to fall within the scope of the present disclosure. Although specific terms are used here, they only convey generic and descriptive meanings and are not intended as restrictions.

1. A charging apparatus, comprising:
a housing adapted to be mounted in a wall;
a power assembly arranged within the housing and configured to supply output power to a device to be charged from a power source;
a temperature sensing unit configured to sense a temperature inside the housing;
a control assembly arranged within the housing and coupled to the power assembly and the temperature sensing unit, the control assembly being configured to control, based on temperature information from the temperature sensing unit, the power assembly to change the output power, thereby suppressing a rise of the temperature inside the housing.

2. The charging apparatus of claim 1, wherein the temperature sensing unit is arranged proximate to at least one of the power assembly and the control assembly, to sense a temperature of at least one of the power assembly and the control assembly.

3. The charging apparatus of claim 2, wherein the power assembly comprises a switching device, and the control assembly comprises a processing unit; and
wherein the temperature sensing unit is arranged proximate to at least one of the switching device and the processing unit, to sense a temperature of at least one of the switching device and the processing unit.

4. The charging apparatus of claim 1, wherein the control assembly is configured to: transmit a signal to the power assembly in response to the temperature information indicating a temperature above a first threshold, to change an output power of the power assembly from a first power to a second power, the second power being lower than the first power.

5. The charging apparatus of claim 4, wherein the control assembly is configured to transmit a signal to the power assembly in response to the temperature information indicating a temperature below a second threshold, to change output power of the power assembly from the second power to the first power, the second threshold being lower than the first threshold.

6. The charging apparatus of claim 1, further comprising:
a USB output port coupled to the power assembly to supply the output power to the device to be charged.

7. The charging apparatus of claim 6, further comprising a voltage and current sensing unit coupled to the power assembly to sense voltages and currents in the power assembly; and
wherein the control assembly is further configured to:
control the power assembly based on voltage and current information from the voltage and current sensing unit and demand information related to charging requirements of the device to be charged from the USB output port.

8. The charging apparatus of claim 7, wherein the control assembly comprises:
a first controller coupled to a switching device of the power assembly and the voltage and current sensing unit, and configured to control ON and OFF of the switching device based on the voltage and current information from the voltage and current sensing unit; and
a second controller coupled to the temperature sensing unit, the USB output port, and the first controller, and configured to provide a command signal to the first controller based on the temperature information from the temperature sensing unit and the demand information from the USB output port, so as to enable the first controller to control ON and OFF of the switching device further based on the command signal.

9. A charging method, comprising:
providing, by a power assembly, an output power from a power source to a device to be charged, wherein the power assembly is arranged within a housing that is adapted to be mounted in a wall;
sensing, by a temperature sensing unit, a temperature inside the housing, wherein the temperature sensing unit is arranged within the housing; and
controlling, by a control assembly, the power assembly based on temperature information from the temperature sensing unit to change the output power, thereby suppressing a rise of the temperature inside the housing.

10. The charging method of claim 9, wherein the temperature sensing unit is arranged proximate to at least one of the power assembly and the control assembly, to sense a temperature of at least one of the power assembly and the control assembly.

11. The charging method of claim 10, wherein the power assembly comprises a switching device, and the control assembly comprises a processing unit; and
wherein the temperature sensing unit is arranged proximate to at least one of the switching device and the processing unit to sense a temperature of at least one of the switching device and the processing unit.

12. The charging method of claim 9, wherein controlling, by the control assembly, the power assembly based on the temperature information from the temperature sensing unit to change the output power comprises:
in response to the temperature information indicating a temperate above a first threshold, transmitting by the control assembly a signal to the power assembly, to change the output power of the power assembly from a first power to a second power, the second power being lower than the first power.

13. The charging method of claim 12, wherein controlling, by the control assembly, the power assembly based on the temperature information from the temperature sensing unit to change the output power further comprises:
in response to the temperature information indicating a temperature below a second threshold, transmitting by the control assembly a signal to the power assembly, to change the output power of the power assembly from the second power to the first power, the second threshold being lower than the first threshold.

14. The charging method of claim 9, further comprising: controlling, by the control assembly, the power assembly based on voltage and current information from a voltage and current sensing unit and demand information related to charging requirements of the device to be charged from the USB output port wherein the voltage and current sensing unit is coupled to the power assembly to sense voltages and currents in the power assembly, and the USB output port is coupled to the power assembly to supply the output power to the device to be charged.
